(19) United States
(12) Patent Application Publication
(10) Pub. No.: US 2008/0165970 A1
(43) Pub. Date: Jul. 10, 2008

(54) RUNTIME MECHANISM FOR FLEXIBLE MESSAGING SECURITY PROTOCOLS

(76) Inventors: Hyen V. Chung, Round Rock, TX (US); Yasumasa Kajinaga, Yokohama-shi (JP); Yuichi Nakamura, Yokohama-shi (JP); Fumiko Satoh, Tokyo (JP); Masayoshi Teraguchi, Yokohama-shi (JP)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/620,474

(22) Filed: Jan. 5, 2007

(51) Int. Cl. H04L 9/28; H04L 9/00; G06F 17/30

(52) U.S. Cl. 380/277; 380/28; 707/104.1; 707/E17.044

(57) ABSTRACT

Methods and arrangements to handle network messages containing security information are disclosed. Embodiments include transformations, code, state machines or other logic to handle network messages containing security information by configuring an application to generate messages containing security information. The configuring may include creating a data structure to store security information of network messages and storing security information, including a specification of a cryptographic key and a specification of a format to represent information about the cryptographic key in the data structure. The embodiments may also include dynamically linking to a runtime module, executing the runtime module, accessing the data structure to identify the cryptographic key and the format to represent the cryptographic key, storing security information in temporary storage based upon the identification of the cryptographic key, constructing a security token based upon the security information stored in temporary storage, and inserting the security token in a message.

### FIELD

The present invention is in the field of data security. More particularly, the present invention relates to methods and arrangements to provide security to messages sent over a network.

### BACKGROUND

Elaborate protocols have been devised to provide security for network messages. This provision of security is important. The data contained in network messages may represent the intellectual capital of a business and form a significant portion of its value. The loss or alteration of the data may represent a loss of capital and may seriously harm the business. In addition, a business may have a legal or contractual duty to preserve the confidentiality of data stored in computer form, such as medical records, credit card numbers, and social security numbers. Allowing unauthorized persons to access the data violates the duty and may expose the business to liability.

Providing security to network messages may include transforming the contents of the messages and adding security information to the messages. The transforming may include encrypting a portion of the contents, generating a numeric summary of the contents (digest) to show that the contents of messages have not changed during transmission, and signing the message to prove the identity of the sender (authentication) and to prevent repudiation of a transaction. The security information may describe the transformations and may include the results of the transformations, to enable a recipient to process the messages. It may also provide evidence to authenticate or otherwise demonstrate the trustworthiness of the sender and receiver of the messages. The information about transformations may describe the use of cryptographic keys for encryption and the digital signatures which were performed on the message. The transformation information may also include the encrypted contents, the values of the digests, and the values of the signatures. The evidence of authentication and trustworthiness may include digital certificates and security tokens.

Security protocols may require a detailed description of the elements of security information. For example, Web Services Security Version 1.0 (WSS), a specification originally submitted to the Organization for the Advancement of Structured Information Standards (OASIS) by IBM, Microsoft, and VeriSign, Inc., provides a protocol using Extensible Markup Language (XML) for including security information in SOAP messages concerned with Web services.

Existing security processors may not allow sufficient flexibility to take advantage of the features provided in security protocols. For example, existing security processors may prohibit custom security tokens or may allow only limited use of custom tokens. These security processors may not allow the use of custom tokens for signature and encryption. Furthermore, they may not permit custom algorithms for such processes as encryption and decryption, digesting, signing, and selecting a token from a security header containing multiple tokens.

### SUMMARY OF THE INVENTION

The problems identified above are in large part addressed by methods and arrangements to handle network messages containing security information. One embodiment provides a method to generate by an application a message containing security information. The method may include configuring the application to generate messages containing security information. The configuring may include creating a data structure to store security information of network messages and storing security information in the data structure. The security information may include a specification of a cryptographic key and a specification of a format to represent information about the cryptographic key. The method may also include dynamically linking to a runtime module, identifying a cryptographic key, storing security information based upon the identification of the cryptographic key; constructing a security token based upon the stored security information, and inserting the security token in the message. Generating the message may include executing the runtime module. Dynamically linking to the runtime module may include plugging-in the runtime module.

Another embodiment may provide a method to process by an application a message containing security information. The method may include configuring the application, dynamically linking to a runtime module, selecting a security token from the message, retrieving a cryptographic key based upon information provided by the security token, storing security information based upon the security token and the cryptographic key, and decrypting a portion of the message with the cryptographic key. Processing the message may include executing the runtime module. Dynamically linking to the runtime module may include plugging-in the runtime module.

### BRIEF DESCRIPTION OF THE DRAWINGS

Advantages of the invention will become apparent upon reading the following detailed description and upon reference to the accompanying drawings in which like references may indicate similar elements:

FIG. 1 depicts a network diagram of an embodiment of a networked system to handle network messages containing security information;

FIG. 2 depicts an embodiment of a computer capable of handling network messages containing security information;

FIG. 3 depicts an embodiment of a message security generator;

FIG. 4 depicts a flowchart of an embodiment to generate security information;

FIG. 5 depicts an embodiment of a message security consumer; and

FIG. 6 depicts a process diagram of an embodiment to execute a custom algorithm.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Generally speaking, methods and arrangements to handle network messages containing security information are contemplated. Embodiments include transformations, code, state machines or other logic to handle network messages containing security information by configuring an application to generate messages containing security information. The configuring may include creating a data structure to store security information of network messages and storing security information in the data structure. The security information may include a specification of a cryptographic key and a specification of a format to represent information about the cryptographic key. The embodiments may also include dynamically linking to a runtime module, executing the runtime module, accessing the data structure to identify the cryptographic key and the format to represent the cryptographic key, storing security information in temporary storage based upon the identification of the cryptographic key, constructing a security token based upon the security information stored in temporary storage, and inserting the security token in a message. The embodiments may include receiving a message, selecting a security token from the message, retrieving a cryptographic key based upon information provided by the security token, and decrypting a portion of the message with the cryptographic key. Processing the received message may include executing the runtime module. In some embodiments, the runtime module may be a plugin. In some embodiments, the runtime module may be invoked by specifying a universal resource identifier (URI).

While specific embodiments will be described below with reference to particular circuit or logic configurations, those of skill in the art will realize that embodiments of the present invention may advantageously be implemented with other substantially equivalent configurations.

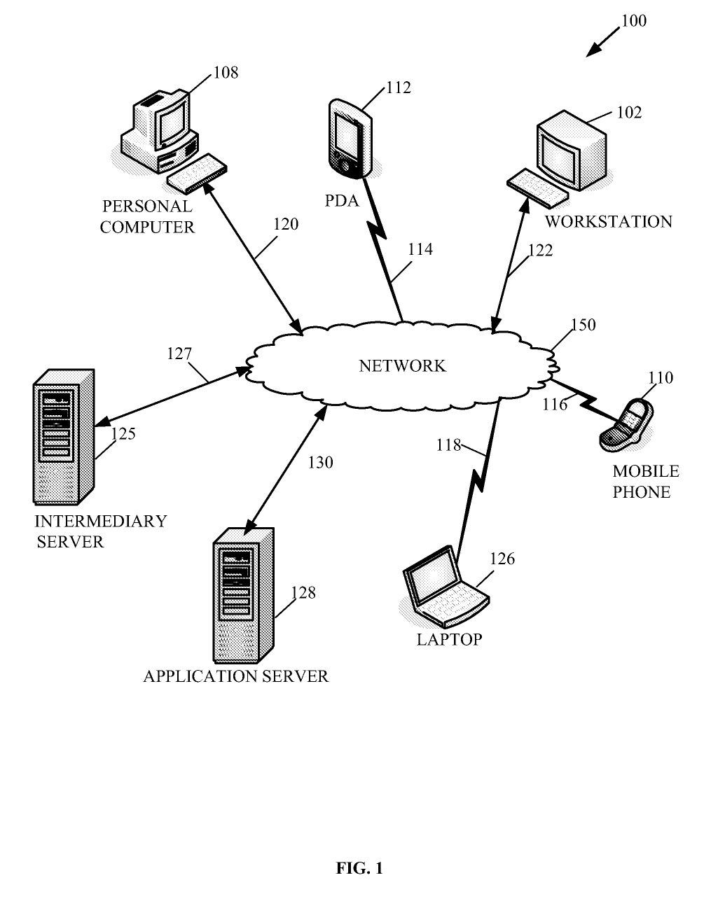

FIG. 1 depicts a diagram of an embodiment of a networked system 100 of devices capable of handling network messages containing security information. Networked system 100 may provide for the transmission of messages containing security information over the Internet and other networks. The system 100 includes a network 150, intermediary server 125 connected to network 150 through wireline connection 127, application server 128 connected to network 150 through wireline connection 130, and a variety of devices capable of handling network messages containing security information (message devices), including:
workstation 102, a computer coupled to network 150 through wireline connection 122,
personal digital assistant 112, coupled to network 150 through wireless connection 114,
personal computer 108, coupled to network 150 through wireline connection 120,
laptop computer 126, coupled to network 150 through wireless connection 118; and
mobile phone 110, coupled to network 150 through wireless connection 116.
   The messages devices may generate, transmit, receive, and process messages containing security information over network 150.

Network 150, which may consist of the Internet or another wide area network, a local area network, or a combination of networks, may provide data communications among the intermediary server 125, application server 128, and message devices 102, 108, 112, 126, and 110. Intermediary server 125 may have installed and operative upon it software to receive, process, and transmit messages containing security information across network 150. Intermediary server 125 may operate as an intermediary node for web services. Web services provide a standardized way of integrating web-based applications. Web services typically provide business services upon request through data communications. Web services intermediaries are web services components, typically servers, that lie between web services requesters and web services ultimate destination servers that deliver the web services. Intermediaries operate generally by intercepting a request from a client, optionally providing intermediary services, and then forwarding the request to an ultimate destination web services provider. Similarly, responses from the web services provider may be intercepted, optionally operated upon, and then returned to the original requester.

Application server 128 may run software applications requested by client computers such as message devices 102, 108, 112, 126, and 110. One example of an application server is IBM® WebSphere® application server. In many embodiments, application server 128 may have installed and operative upon it software to handle network messages containing security information transmitted across network 150. Application server 128 may generate security information, insert the information in messages, and transmit the messages over network 150. Conversely, application server 128 may receive messages over network 150 and process the security information contained in them. In these embodiments, application server 128 may generate messages containing security information by dynamically linking to runtime modules such as plug-ins, identifying cryptographic keys, storing security information based upon the identification of the cryptographic keys, constructing security token based upon the stored security information, and inserting the security tokens in the messages. Generating the messages may include executing the runtime modules. In other embodiments, the applications run by application server 128 may perform their own processing of security information in messages the applications send and receive. In still other embodiments, the processing of security information may be shared by the applications and the application server 128.

Message devices such as devices 102, 108, 112, 126, and 110 may handle security information in messages. They may generate security information, insert the information in messages, send the messages, receive messages containing security information, and process the security information.

The arrangement of the server and other devices making up the exemplary system illustrated in FIG. 1 is for explanation, not for limitation. Data processing systems useful according to various embodiments of the present invention may omit a server, or may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

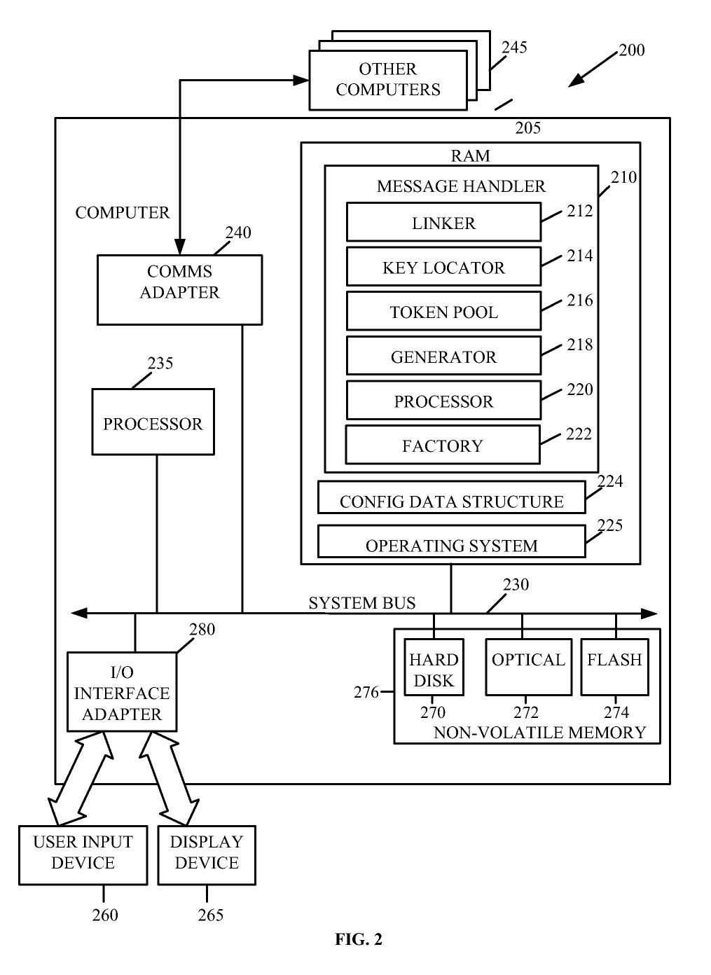

Turning to FIG. 2, depicted is an embodiment of a computer 200 capable of handling network messages containing security information that includes random access memory (RAM) 205, a processor 235 or CPU, non-volatile memory 276, a communications adapter 240, and an Input/Output (I/O) interface adapter 280 connected by system bus 230. Stored in RAM 205 is a message handler 210, a configuration data structure 224, and an operating system 225.

Message handler 210 may comprise computer program instructions to generate and process security information for messages transmitted over a network. Message handler 210 includes linker 212, key locator 214, token pool 216, generator 218, processor 220, and factory 222. Linker 212 may dynamically link other programs to message handler 210 for the handling of security information. Linker 212 may, for example, provide an interface for plugging in the other programs to message handler 210. Key locator 214 may retrieve a cryptographic key used for encrypting or decrypting a message, for signing a message, or for verifying a signature. In the generation of messages, key locator 214 may retrieve a key from a key store file. In the processing of messages, key locator 214 may retrieve a key from the security information in the message. Token pool 216 may be used for communicating information about keys between modules. In message generation, key locator 214 may store key information about a key for use by a token generator. In message processing or consumption, a token consumer may store information for use by key locator 214.

Generator 218 generates security information for messages, the generation including the selection of cryptographic keys and the creation of tokens. Processor 220 processes security information in messages. Factory 222 may be used to create custom algorithms for use in the generation and consumption of security information in messages. Configuration data structure 224 is a data structure containing information for generating and processing security information in network messages. The information may include specifications of cryptographic key, specifications of formats to represent information about cryptographic keys, and specifications of methods to select a security token of a requester when multiple security tokens are contained in network messages.

Operating system 225 may comprise UNIX™, Linux™, Microsoft Windows™, AIX™, IBM's i5/OS™, or other operating systems useful for handling network messages containing security information as will occur to those of skill in the art. Message handler 210 and operating system 225 (components of software) are shown in RAM 205 in FIG. 2, but many components of such software may be stored in non-volatile memory 276 also. Further, while the components of such are shown simultaneously present in RAM, in other embodiments, only some of the components of RAM 205 may be present at any given time

I/O interface adapter 280 implements user-oriented I/O through, for example, software drivers and computer hardware for controlling output to display devices such as display device 265 as well as user input from user input device 260. User input device 260 may include both a keyboard and a mouse. Some embodiments may include other user input devices such as speech interpreters, bar code scanners, text scanners, tablets, touch screens, and/or other forms of user input devices. Non-volatile computer memory 276 may be implemented as a hard disk drive 270, optical disk drive 272, electrically erasable programmable read-only memory space (EEPROM or Flash memory) 274, RAM drives (not shown), or as any other kind of computer memory as will occur to those of skill in the art.

Communications adapter 240 may implement the hardware level of data communications through which one computer sends data communications, such as messages containing security information, to other computers 245, directly or through a network. Such data communications may be carried out through serially through RS-232 connections, through external buses such as USB, through data communications networks such as IP networks, and in other ways as will occur to those of skill in the art. Examples of communications adapters include modems for wired dial-up communications, Ethernet (IEEE 802.3) adapters for wired network communications, and 802.11b adapters for wireless network communications.

The computer and components illustrated in FIG. 2 are for explanation, not for limitation. In other embodiments, modules to handle the security information in messages transmitted over a network may be implemented in hardware, firmware, or in state machines or may form a component of an operating system.

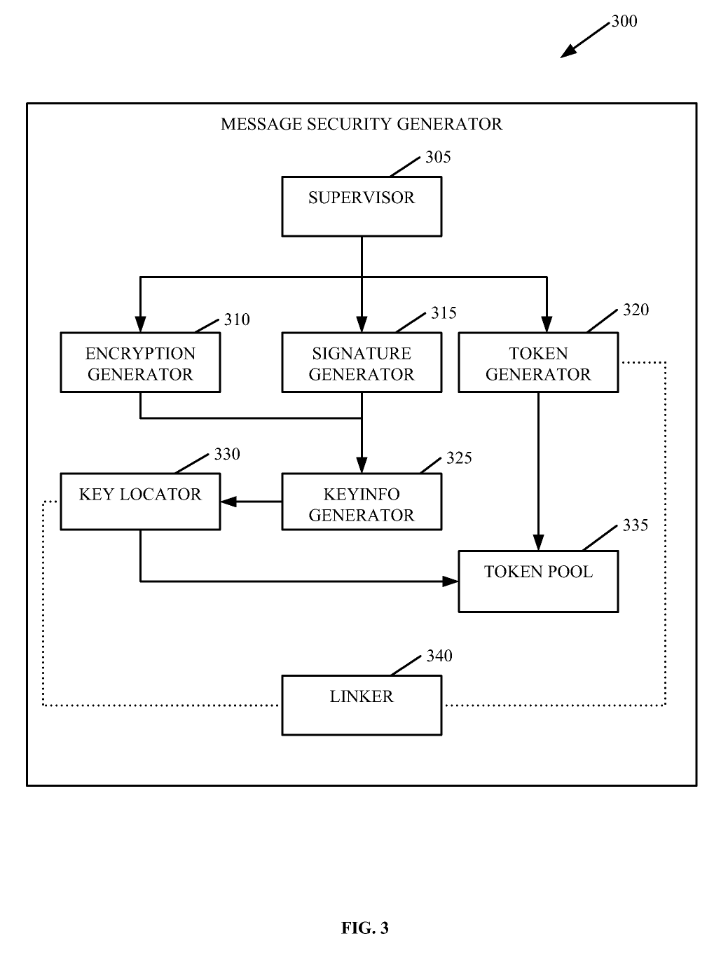

FIG. 3 illustrates an embodiment of a message security generator 300 that includes a supervisor module 305, an encryption generator 310, a signature generator 315, a token generator 320, a key information generator 325, a key locator 330, a token pool 335, and a linker 340. The arrows indicate the flow of control. Thus, for example, key information generator 325 may call key locator 330. Message security generator 300 may produce security information for insertion into a message by applying algorithms to the content of the message and by creating elements of a security protocol to describe the proper handling of the message.

The algorithms may involve encryption, digesting or hashing, and signing. Encryption is the process of transforming information into a form which is not readily understandable. The reverse process, decryption, involves restoring the information to an understandable form. Cryptography includes both processes. Often cryptography uses a secret piece of information, called a key, to perform the encryption and decryption. Typically, the key is an input to a mathematical algorithm that performs the transformations. The algorithm may be symmetric or asymmetric. Symmetric algorithms use the same key for encryption and decryption. Asymmetric algorithms use a pair of keys, often a public key and a private key obtained from a public key/private key infrastructure. The security information may describe the algorithms.

A hash or digest is a mathematical transformation of the contents of a message or other document into a short string of data, such as 160 bits. The transformation is designed to be one-way—difficult to construct a message with a given hash value. A hash may be used to show the integrity of data transmitted across a network. A recipient of the message may be provided with the hash algorithm and the value resulting from a hash of the message before transmission. The recipient may perform a hash of the message as received. If the two hash values are equal and the recipient trusts that the hash value was not tampered with, the recipient may trust that the message was not changed during transmission.

A signature combines hashing and encryption, and may be used both to prove the identity of (authenticate) the signer and to show the integrity of the contents of the message. A signature or digital signature is a transformation of a message that can only be produced by use of certain private information. The creation of the signature may prove possession of the private information. Signing a message is often carried out by hashing a message and encrypting the hash with the signor's private key in a public key/private key infrastructure. A recipient may verify a signature by decrypting the signature with the signor's public key, thereby obtaining a purported hash of the request. The recipient may compare the purported hash with a hash of the message as received. The equality of the two hashes may confirm both the identity of the sender and the integrity of the message. The signer may be known, since the public key can only decrypt a message encrypted with the signer's private key. An authority may issue certificates verifying the identity of the issuer of a public key. Further, the integrity of the message during transmission is verified. Had the message been changed in transmission, the hash of the message as sent would not equal the hash of the message as received.

The elements of a security protocol may include descriptions of the algorithms and may include security tokens for authentication or otherwise to establish trust. The following SOAP message illustrates the elements of a security protocol that may be included in a message:

```
<?xml version=“1.0” encoding=“utf-8”?>
<S:Envelope xmlns:S=“http://www.w3.org/2001/12/soap-envelope”
xmlns:ds=“http://www.w3.org/2000/09/xmldsig#”>
  <S:Header>
    <wsse:Security
    xmlns:wsse=“http://schemas.xmlsoap.org/ws/2002/04/secext”>
        <wsse:BinarySecurityToken ValueType=“wsse:X509v3“...
        wsu:Id=“X509Token”>
        MIIEZzCCA9CgAwIBAgIQEmtJZc0rqrKh5i...
        </wsse:BinarySecurityToken>
      <ds:Signature>
        <ds:SignedInfo>
          <ds:CanonicalizationMethod
            Algorithm=“http://www.w3.org/2001/10/xml-exc-c14n#”/>
          <ds:SignatureMethod
          Algorithm=“http://www.w3.org/2000/09/xmldsig#hmac-
          shal”/>
          <ds:Reference URI=“#MsgBody”>
          <ds:DigestMethod
          Algorithm=“http://www.w3.org/2000/09/xmldsig#shal”/>
          <ds:DigestValue>LyLsF0Pi4wPU...</ds:DigestValue>
          </ds:Reference>
        </ds:SignedInfo>
      <ds:SignatureValue>DJbchm5gK...</ds:SignatureValue>
      <ds:KeyInfo>
      <wsse:SecurityTokenReference>
      <wsse:Reference URI=“#X509Token”/>
      </wsse:SecurityTokenReference>
      </ds:KeyInfo>
    </ds:Signature>
  </wsse:Security>
</S:Header>
<S:Body Id=“MsgBody”>
<tru:StockSymbol xmlns:tru=“http://fabrikam123.com/payloads”>
QQQ
</tru:StockSymbol>
</S:Body>
</S:Envelope>
```

This SOAP message is in XML (Extensible Markup Language) format. An XML element begins with “<” followed by the name of the element and ends with “/>”. A one-line element may contain a single set of brackets, such as <simple-element />. A more complicated element may begin and end with pairs of brackets, such as <simple-element></simple-element>. Elements may contain values or attribute-value pairs, of the form “attribute=value.” Elements may themselves contain elements, and so on, recursively. For example, the envelope element contains (wraps) the entire message except for the first line.

The example SOAP message is composed of two portions. The header, which extends from line 27 of page 10 to line 14 of page 11, contains administrative information about the processing of the message. One element of the header is the security element (lines 28 of page 10 to line 13 of page 11). The security element contains the security information of the message.

Lines 30 through 33 contain a binary security token. A security token is an element used to prove the identity of a participant in the message or to indicate the amount of trust to give. The ValueType attribute of the security token on line 30 indicates that the security token is an X.509 certificate. Lines 34 through line 12 page 11 specify a digital signature. The signature uses the XML Signature specification. Lines 36 to 37 specify how to canonicalize or put into standard form the data that is being signed. Lines 38 to 39 specify the algorithm used to perform the signature.

The reference element (line 40) specifies the elements that are signed. In this case, an element named “MsgBody” is signed. That element is the body (lines 15 through 19 of page 11) of the message. The DigestMethod element (lines 1 to 2 of page 11) specifies the algorithm for taking the digest of the signed element. Line 3 of page 11 provides the digest value and line 6 provides the value of the signature, the result of encrypting the digest value by the specified encryption method. The SecurityTokenReference (lines 8 to 10, page 11) specifies a security token that may prove that the claimed issuer of a public key used to verify the signature is indeed the issuer of the key.

The body of the SOAP is contained in lines 15 through 19 of page 11. The ID attribute of the body provides the name MsgBody for the body. This name is used by the signature to refer to the body. Anyone who reads the message may understand the information in the body. In other cases, encryption of the message body may be desirable to preserve confidential information. In such cases, the security header may specify the encryption algorithm. The message body may be encrypted with a different key than the key used for signature.

In the above example, the security information included a security token and a signature that used a cryptographic key. Producing the information required the application of several algorithms, including a digest method, a canonicalization method, and a signature method. The components of FIG. 3 may produce these types of security information and apply these types of algorithms.

In the example of FIG. 3, supervisor module 305 may call on encryption generator 310 to encrypt data in a message. Signature generator 315 may sign messages. The signing may include putting the data to be signed in canonical form, calculating the digest of the data, and encrypting the digest. Token generator 320 may generate tokens for inclusion in messages. The tokens may be used to verify the issuer of keys used in signatures and to establish trust between transmitters and receivers of messages. Token generator 320 may place the tokens in token pool 335. In some embodiments, token pool 335 may consist of a temporary buffer to store the tokens that are generated for a single message. In further embodiments, this use of token pool 335 may enable the implementation of token generator 320 without regard for the use of tokens for signature/encryption. Such separation of function may contribute to the usability of the message security generator architecture.

Both encryption generator 310 and signature generator 315 may invoke keyinfo generator 325. Keyinfo generator 325 may generate the portions of message security information that describe the keys used for encryption or signing. Keyinfo generator 325 may invoke key locator 330 to retrieve a key, such as from a key store file. Message security generator 300 may, for example, have access to a variety of keys for encryption and signature and may use different keys for different purposes. The key store file may contain a store of keys and information about the keys such as the encryption algorithms and security tokens that attest to the identity of the key issuers. Key locator 330 may return a key, using information about the key contained in a token in token pool 335 to select the key.

A typical order of processing by message security generator 300 may be as follows:
1. Token generator 320 creates tokens and put them in token pool 335.
2. Signature generator 315 invokes keyinfo generator 325 and key locator 330 to retrieve a key for signing.
3. Key locator 330 finds a key for signature, referring to the information about the key in token pool 335.
4. Signature generator 315 produces a signature or signatures, using the retrieved key.
5. Encryption generator 310 invokes keyinfo generator 325 and key locator 330 to retrieve a key for encryption.
6. Key locator 330 finds a key for encryption, referring to the information about the key in token pool 335.
7. Encryption generator 310 encrypts a portion or portions of a message, using the retrieved key.

Message security generator 300 may access a configuration data structure to simplify the task of generating the security information for inclusion in a message. The configuration data structure may include specifications of cryptographic keys and specifications of formats to represent the information about the keys. The configuration data structure may also include information about security requirements, default settings for a platform, and organized sets of values of security parameters.

Linker 340 may provide an interface to enable dynamically linking software modules such as plug-ins to message security generator 300. The dotted lines of FIG. 3 indicate two modules that may be dynamically linked to message security generator 300 to provide flexibility and extendibility. A dynamically-linked token generator 320 may enable the use of custom tokens for authentication, for signing or for encrypting. A dynamically-linked key locator 330 may allow for the retrieval of custom keys for encryption and signing from the token pool.

The components of FIG. 3 and their arrangement are for illustration and not limitation. In some other embodiments, message security generators may contain different components than those shown in FIG. 3, or may contain the same components organized in a different manner as will occur to those of skill in the art. In many other embodiments, a linker may provide dynamic linking to other components or subcomponents or may omit dynamic linking to some of the components shown above.

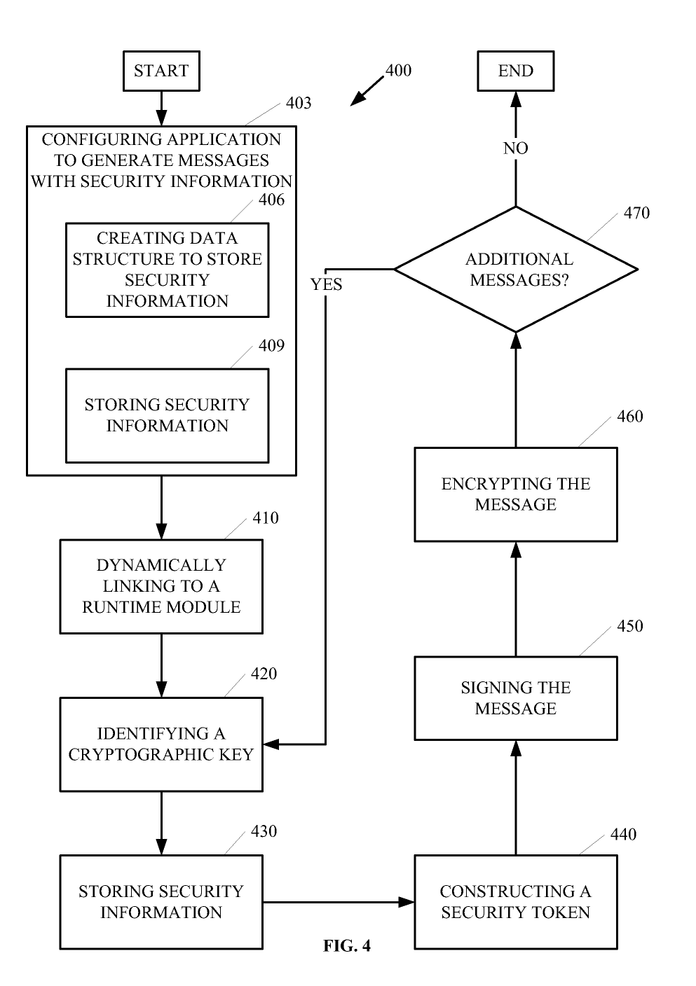

Turning to FIG. 4, depicted is a flowchart 400 of an embodiment to generate security information by a message security generator such as message security generator 300. Flowchart 400 begins with configuring an application to generate messages containing security information (element 403). The configuring may include creating a data structure to store security information (element 406). The data structure may be accessible by multiple applications served by a single web server. The configuring may also include storing security information in the data structure for use by applications generating network messages (element 409). The security information may include specifications of cryptographic keys and specifications of formats to represent information about the keys. The security information may also include information about security requirements, default settings for a platform, and organized sets of values of security parameters.

The message security generator may dynamically link to a runtime module (element 410). The runtime module may, for example, plug in to the message security generator. The run-time module may generate a custom token, perform a custom algorithm for signature or encryption, or otherwise extend the capabilities of the message security generator.

The message security generator may identify a cryptographic key (element 420). The cryptographic key may be retrieved from a key depository. For example, the depository may maintain a variety of keys for use a variety of purposes of a variety of audiences. Information about the key and other security information retrieved from the depository may be stored (element 430) in a token pool or other memory. The message security generator may construct a security token for insertion into a message (element 440). The token may be used to authenticate the sender of the message, to provide information about a cryptographic key used to provide security for the message, or to establish trust between an entity attested to by the token and a recipient of the message.

The message security generator may sign the message (element 450). The message security generator may encrypt the message (element 460). If there are additional messages (element 470), elements 420 through 460 may be repeated. If there are no additional messages, the generation of security information may end.

The elements of flowchart 400 are for illustration and not for limitation. In alternative embodiments, some of the elements of flowchart 400 may be omitted or others may be added. For example, in some embodiments, a message may be signed but not encrypted. In other embodiments, a message may be encrypted but not signed. In still other embodiments, a message may be sent with security tokens but neither signed nor encrypted.

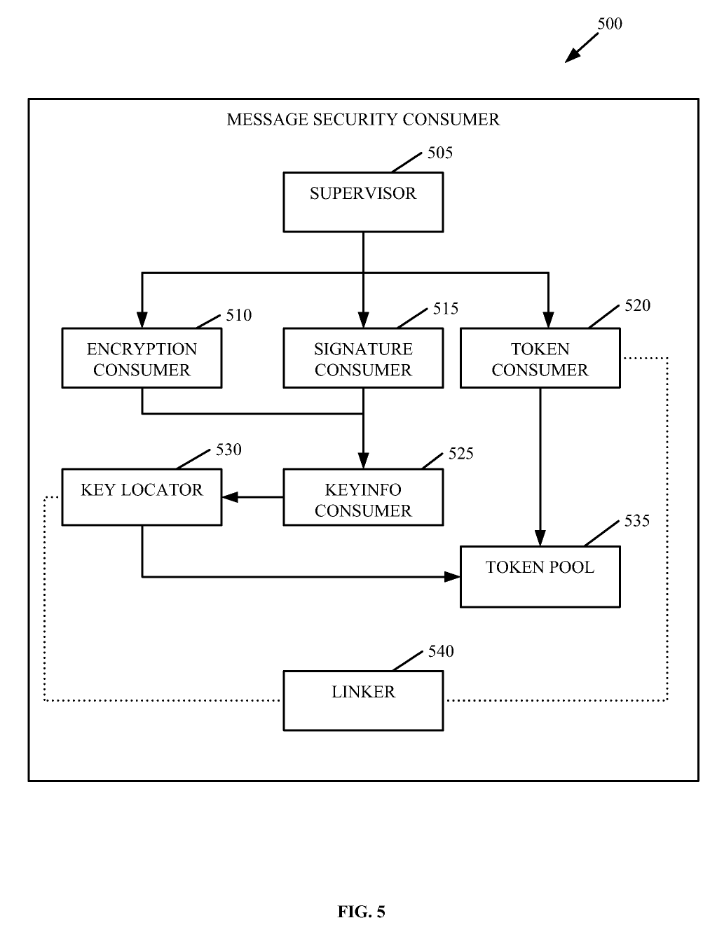

FIG. 5 illustrates an embodiment of a message security consumer 500 that includes a supervisor module 505, an encryption consumer 510, a signature consumer 515, a token consumer 520, a key information consumer 525, a key locator 530, a token pool 535, and a linker 540. The arrows indicate the flow of control. Thus, for example, key information consumer 525 may invoke key locator 530. Message security consumer 500 may process security information contained in a message sent over a network.

In the example of FIG. 5, supervisor module 505 may call on token consumer 520 to interpret a security token or tokens contained in a message. The message may contain several security tokens, and token consumer 520 may select one or several to interpret. The security token or tokens may contain information describing a cryptographic key or keys used to provide security for the message, authenticate a sender of the message, or establish trust to one of the parties to the message. Token consumer 520 may place extract the token or tokens and store them in token pool 535. In some embodiments, token pool 535 may consist of a temporary buffer to store tokens that are extracted from a single message. A single message may have multiple tokens stored in token pool 535. In further embodiments, this use of token pool 535 may enable the implementation of token consumer 520 without regard for the use of tokens for signature/encryption. Such separation of function may contribute to the usability of the message security consumer architecture.

If the message is signed, supervisor module 505 may invoke signature consumer 515 to verify the signature. Signature consumer 515 may invoke keyinfo consumer 525 to interpret information about a key used to produce the signature. Keyinfo consumer 525 may invoke key locator 530 to locate the key. Key locator 530 may refer to a token stored in token pool 535 to obtain information about the key. Key locator 530 may retrieve the key using the information. The key may be passed to keyinfo consumer 525 and to signature consumer 515. Signature consumer 515 may use the key to perform signature verification.

Message security consumer 500 may undergo a similar process to decrypt an encrypted message. Token consumer 520 may place information about the key used for encryption in token pool 535. The key may be different than a key used for a signature, if any. Keyinfo consumer 525 and key locator 530 may retrieve a key for decryption. The key may be the same as the key used for encryption, in case of a symmetric key; or a key from a private-public key pair when the other key of the pair was used for the encryption. Encryption consumer 510 may apply the key to decrypt the message.

Message security consumer 500 may access a configuration data structure to simplify the task of processing the security information included in a message. The information may include a policy or policies about the degree of trust to be given to messages. A policy may specify a list of trusted senders, a list of trusted certification authorities, or a combination of both. For example, a message may be trusted if the sender can produce a chain of endorsements by certification authorities beginning with a trusted endorsement. The degree of trust provided a message may be based upon security tokens contained in the message.

In particular, the policy may describe the treatment of a message containing multiple security tokens. When a message requesting Web services travels via an intermediary or intermediaries, such as intermediary server 125 in FIG. 1, the message may contain tokens of the original requester and the intermediary or intermediaries. In that case, a security policy may direct the selection of a token to identify the requester, and may also specify the selection of a token for determining a degree of trust. For example, the policy may select a username in a UsernameToken element, and may trust an intermediary based on its digital signature and a token that is a part of the digital signature.

More generally, a configuration data structure may contain a complete set of policies for processing security information. The policies may describe the security features required in a network message and how to process the security information provided in the network message. For example, message security consumer 500 may process SOAP messages containing requests for Web Services. The policies specified in a configuration data structure may require the security information in the messages to comply with the WSS specification for security for Web services. The policies may specify the selection of a token to determine the identity of a requester when a message contains multiple messages.

Linker 540 may provide an interface to enable dynamically linking software modules such as plug-ins to message security consumer 500. The dotted lines of FIG. 5 indicate two modules that may be dynamically linked to message security generator 500 to provide flexibility and extendibility. A dynamically-linked token consumer 520 may enable the use of custom tokens for authentication, signing, or encryption. A dynamically-linked key locator 530 may enable the retrieval of custom keys for encryption and signing. It may also enable the use of a custom algorithm to select for processing one or more tokens from multiple tokens in a message.

The components of FIG. 5 and their arrangement are for illustration and not limitation. In other embodiments, message security consumers may contain different components than those shown in FIG. 5, or may contain the same components organized in a different manner as will occur to those of skill in the art.

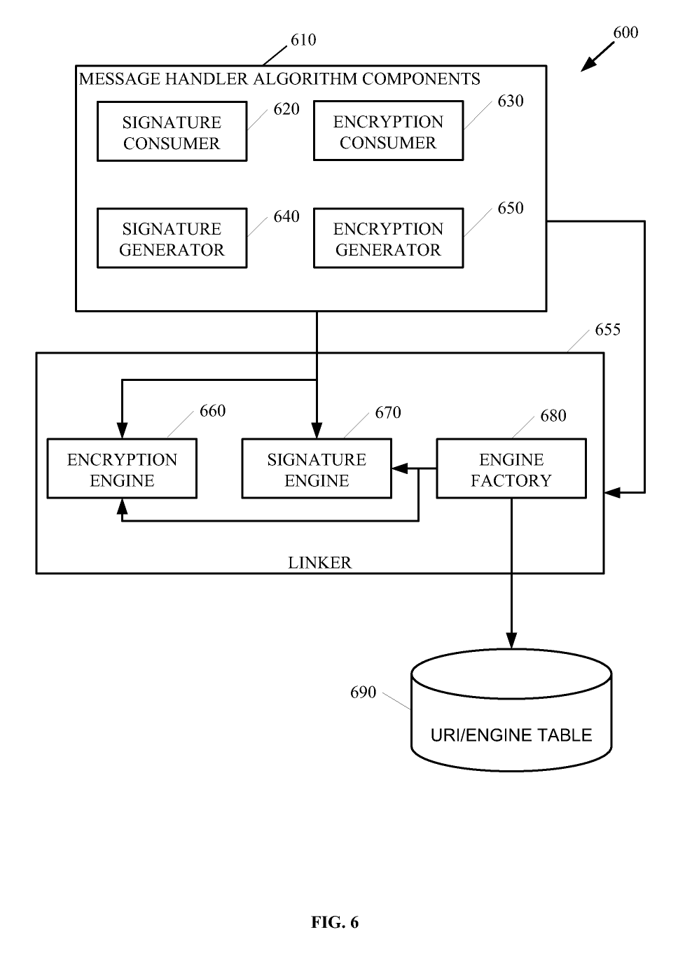

FIG. 6 depicts a process diagram 600 of an embodiment to execute a custom algorithm. Arrows shows process flow from one component to another. Diagram 600 includes message handler algorithm components 610, linker 655, and URI/engine table 690. Message handler algorithm components 610 contains components of a message handler that may use algorithms and includes signature consumer 620, encryption consumer 630, signature generator 640, and encryption generator 650. The signature modules may perform an algorithm to sign a message or verify the signature of a message, and the encryption modules may encrypt or decrypt a message.

One of the components of message handler algorithm components 610 may require a custom algorithm, such as for signature or encryption. The component may invoke linker 655. Linker 655 may create an instance of engine factory 680. Engine factory 680 may obtain the appropriate engine, such as an encryption engine 660 or signature engine 670, from URI/engine table handler 690. The algorithm component 610 may then invoke the engine, such as encryption engine 660 or signature engine 670, to perform the appropriate algorithm. In some embodiments, the invocation of linker 655 to create custom engines may be identical for each of the algorithm components 620, 630, 640 and 650, except for the specification of a different URI or other algorithm identifier for the algorithm. For example, the invocation of linker 655 by each of the algorithm components 620, 630, 640 and 650 may consist of a call to the same function with a URI as an argument.

The engine factory 680, signature engine 670, and encryption engine 660 may operate as plugins. A plugin is an auxiliary computer program that interacts with a main application. Typically, the main application provides an application programming interface (API), a set of commands for interacting with the main application. The plugin may, for example, obtain necessary data by making function calls defined by the API. Conversely, the plugin may make information available to users of the main application by defining other function calls provided by the main interface. Plugins generally are for a specific purpose and rely on the interface of the main application. Plugins may register with the main application.

The process diagram of FIG. 6 is for illustration and not limitation. A message handler may enable the use of a custom engine to perform algorithms for processing security information in a variety of ways. Custom engines may provide functionality to a security message handler as an extension, through the use of middle ware, through dynamically-linked modules, and other programming paradigms as will occur to those of skill in the art. Custom engines may provide functionality other than for signature and encryption, such as digests, algorithms to determine the amount of trust to give to the provider of a security token, algorithms to select a token or tokens when a message contains multiple tokens, and other algorithms as may occur to those of skill in the state of the art.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product to handle messages containing security information accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods and arrangements to handle messages containing security information. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A runtime method to generate messages containing security information, the method comprising:
configuring an application, the configuring comprising:
creating a data structure to store security information of network messages; and
storing security information in the data structure, the security information including a specification of a cryptographic key and a specification of a format to represent information about the cryptographic key;
dynamically linking to a runtime module;
executing the runtime module;
accessing the data structure to identify the cryptographic key and the format to represent the cryptographic key;
storing security information in temporary storage based upon the identification of the cryptographic key and the identification of the format;
constructing a security token based upon the security information stored in temporary storage; and
inserting the security token in a message.

2. The method of claim 1, wherein executing the runtime module comprises constructing the security token.

3. The method of claim 1, wherein executing the runtime module comprises performing encryption with the cryptographic key.

4. The method of claim 1, wherein executing the runtime module comprises accessing the
data structure to identify the cryptographic key and the format to represent the cryptographic key.

5. The method of claim 1, wherein executing the runtime module comprises invoking the runtime module with a universal resource identifier (URI) as input.

6. A runtime method to process messages containing security information, the method comprising:
configuring an application to process messages containing security information, the configuring comprising:
creating a data structure to store security information of network messages; and
storing security information in the data structure, the security information including a specification of a method to select a security token of a requester when multiple security tokens are contained in network messages;
dynamically linking to a runtime module;
applying the method to select a security token of a requester to select a security token from a message;
retrieving a cryptographic key based upon information provided by the security token;
storing security information in temporary storage based upon the security token and the cryptographic key; and
decrypting a portion of the message with the cryptographic key.

7. The method of claim 6, wherein executing the runtime module comprises selecting a security token from the message.

8. The method of claim 6, wherein executing the runtime module comprises determining the amount of trust to give to an entity certified by the security token.

9. The method of claim 6, wherein executing the runtime module comprises decrypting a portion of the message with the cryptographic key.

10. An apparatus to handle messages containing security information, the apparatus comprising:
a storage to store security information of network messages, the security information to include a specification of a cryptographic key, a specification of a format to represent information about the cryptographic key, and a specification of a method to select a security token of a requestor when multiple security tokens are contained in network messages;
a linker to dynamically link to a runtime module and to invoke the runtime module;
a key locator to identify a cryptographic key based upon the specification of a cryptographic key in the storage;
a token pool to store security information based upon the identification of the cryptographic key; and
a token generator to construct a security token based upon the stored security information.

11. The apparatus of claim 10, further comprising a generator to generate messages containing security information.

12. The apparatus of claim 10, further comprising a processor to receive and process messages containing security information based upon the specification of a method to select a security token of a requester.

13. The apparatus of claim 10, further comprising a factory to generate engines to utilize the cryptographic key in encryption.

14. The apparatus of claim 13, wherein the factory is a plug-in module.

15. The apparatus of claim 10, wherein the linker comprises a module to invoke the factory by specifying a universal resource identifier (URI).

16. A computer program product to process messages containing security information, the computer program product comprising a computer useable medium having a computer readable program, wherein the computer readable program when executed on a computer causes the computer to:
configure an application to process messages containing security information, the configuring comprising:
creating a data structure to store security information of network messages; and
storing security information in the data structure, the security information including a specification of a method to select a security token of a requestor when multiple security tokens are contained in network messages;
dynamically link to a runtime module;
apply the method to select a security token to select a security token from a message;
retrieve a cryptographic key based upon information provided by the security token;
store security information in temporary storage based upon the security token and the cryptographic key; and
decrypt a portion of the message with the cryptographic key.

17. The computer program product of claim 16, wherein:
the computer readable program which causes the computer to configure the application comprises a computer readable program which causes the computer to store a specification of a cryptographic key and a specification of a format to represent information about the cryptographic key in the data structure; and
the computer readable program further causes the computer to:
access the data structure to identify the cryptographic key and the format to represent the cryptographic key;
store security information in temporary storage based upon the identification of the cryptographic key and the identification of the format;
construct a security token based upon the security information stored in temporary storage; and
insert the security token in a message.

18. The computer program product of claim 16, wherein the computer readable program which causes the computer to execute the runtime module comprises a computer readable program which causes the computer to invoke the runtime module with a universal resource identifier (URI) as input.

19. The computer program product of claim 16, wherein the computer readable program which causes the computer to execute the runtime module comprises a computer readable program which causes the computer to decrypt a portion of the message with the cryptographic key.

20. The computer program product of claim 16, wherein the computer useable medium comprises a transmission medium.
